(19) United States
(12) Patent Application Publication
(10) Pub. No.: US 2018/0205092 A1
(43) Pub. Date: Jul. 19, 2018

(54) METHOD FOR PRODUCING FUEL CELL CATALYST LAYER

(71) Applicant: TOYOTA JIDOSHA KABUSHIKI KAISHA, Toyota-shi (JP)

(72) Inventors: Tatsuya ARAI, Susono-shi (JP); Takashi OZAKI, Gotemba-shi (JP)

(73) Assignee: TOYOTA JIDOSHA KABUSHIKI KAISHA, Toyota-shi (JP)

(21) Appl. No.: 15/840,914

(22) Filed: Dec. 13, 2017

(30) Foreign Application Priority Data
Jan. 19, 2017 (JP) 2017-007875

(51) Int. Cl. H01M 4/88; H01M 4/92; H01M 8/1039; H01M 4/86

(52) U.S. Cl. CPC H01M 4/8857; H01M 4/881; H01M 2008/1095; H01M 8/1039; H01M 4/8663; H01M 4/925

(57) ABSTRACT

A method for producing a fuel cell catalyst layer configured to prevent an increase in cell resistance, have excellent IV characteristic, and be even. The method includes the steps of: preparing a catalyst composite that comprises a titanium oxide support and platinum or a platinum alloy supported on a surface thereof, and an ionomer; mixing the catalyst composite, the ionomer, and a dispersion medium containing at least water and a tertiary alcohol having from 4 to 6 carbon atoms where a content ratio of the tertiary alcohol is the highest; and, while pulverizing aggregates comprising the catalyst composite and the ionomer, dispersing a mixture obtained by the pulverization in the dispersion medium.

### TECHNICAL FIELD

One or more embodiments disclosed and described herein relate to a method for producing a fuel cell catalyst layer configured to prevent an increase in cell resistance, have excellent IV characteristic, and be even.

### BACKGROUND

The electrolyte membrane of a fuel cell needs to be kept in a wet state to maintain proton conductivity. In the prior art, therefore, air or hydrogen is humidified in advance before it is supplied to the fuel cell. However, this is not preferable since a humidifier or the like is required to humidify the gas and makes fuel cell system complicated. Due to this reason, there is a demand for a fuel cell that can generate power even in a non-humidified state.

A fuel cell catalyst layer operable in a non-humidified state is disclosed in Patent Literature 1, which comprises an ionomer, a catalyst and a carbon support supporting the catalyst, where the mass ratio of carbon (C) and the ionomer (I) is represented by 0.4≤I/C≤1.25 in both an anode and a cathode.

Non-Patent Literature 1 discusses the long-term stability of a fuel cell in the case of using Pt/IrO₂—TiO₂ as a cathode catalyst. The abstract of Non-Patent Literature 1 describes that an optimum is found for 10 mass % ionomer content with respect to the catalyst mass.
Patent Literature 1: Japanese Patent Application Laid-Open No. 2002-100367
Non-Patent Literature 1: Patru, A et al., “Pt/IrO2-TiO2 cathode catalyst for low temperature polymer electrolyte fuel cell—Application in MEAs, performance and stability issues”, Catalysis Today 262 (2016) 161-169

It is known that if the anode of a fuel cell partially lacks in hydrogen gas, high potential is applied to the anode. In this case, in the anode catalyst layer of the fuel cell, the anode catalyst layer including a carbon support, the carbon support is deteriorated by oxidation and, therefore, the power generation performance of the fuel cell is significantly decreased.

As an approach to solving the problem, it is considered to use a titanium oxide support that is stable in a reducing atmosphere and resistant to high potential, as a material for the anode. However, the titanium oxide support has material characteristics that are different from the carbon support. Therefore, even if the anode catalyst layer is formed in a conventional manner using the titanium oxide support, it is difficult to obtain the same power generation performance as the case of using the carbon support.

Patent Literature 1 explains a water distribution state in a fuel cell (FIG. 2). In this explanation, however, there is no reference to partial lack of supply gas in the fuel cell when it is in a non-humidified state.

In Non-Patent Literature 1, an aqueous solution of isopropyl alcohol is provided as the dispersion medium of a catalyst ink. In Non-Patent Literature 1, it is also described that the catalyst layer is formed by a spraying method (2.2. MEA manufacture). However, these catalyst layer forming conditions are those of the case of using a conventional carbon support, and they cannot solve the problems that are specific to the case of using a titanium oxide support.

### SUMMARY

One or more embodiments disclosed and described herein were achieved in light of the above circumstance of the fuel cell catalyst layer. An object of the one or more embodiments disclosed and described herein, is to provide a method for producing a fuel cell catalyst layer configured to prevent an increase in cell resistance and have excellent IV characteristic.

In a first embodiment, there is provided a method for producing a fuel cell catalyst layer, the method comprising the steps of: preparing a catalyst composite that comprises a titanium oxide support and platinum or a platinum alloy supported on a surface thereof, the titanium oxide support comprising Ti₄O₇ as a main component, and an ionomer that is a proton-conductive polymer; mixing the catalyst composite, the ionomer, and a dispersion medium containing at least water and a tertiary alcohol having from 4 to 6 carbon atoms where a content ratio of the tertiary alcohol is the highest, in such conditions that a ratio (I/MO) of a mass (I) of the ionomer to a mass (MO) of the titanium oxide support is in a range of from 0.12 to 0.16, and a content of a solid comprising the catalyst composite and the ionomer is 24 mass % or more; and, while pulverizing aggregates comprising the catalyst composite and the ionomer by use of at least one medium selected from the group consisting of a gas, a liquid, and a solid having a Vickers hardness lower than titania, dispersing a mixture obtained by the pulverization in the dispersion medium.

The method may comprise the step of forming a catalyst layer on a surface of an electrolyte membrane by at least one method selected from the group consisting of a casting method, a screen printing method, a doctor blade method, a gravure printing method and a die coating method.

The ratio (I/MO) is preferably from 0.14 to 0.16.

The tertiary alcohol is preferably diacetone alcohol or t-butyl alcohol.

A high-shear mixer or a homogenizer is preferably used in the dispersing step.

The fuel cell catalyst layer is preferably a fuel cell catalyst layer for an anode.

According to the production method of the one or more embodiments disclosed and described herein, physical damage to the titanium oxide support and chemical deterioration thereof, are minimized by mixing the materials for the catalyst layer by the use of the specific dispersion medium in the specific ratio (I/MO) and solid content conditions in the mixing step, and using the specific medium in the dispersing step. As a result, the fuel cell catalyst layer configured to prevent an increase in cell resistance, have excellent IV characteristic, and be even, can be produced.

### BRIEF DESCRIPTION OF THE DRAWINGS

In the accompanying drawings,

FIG. 1 is a view of an example of the layer configuration of a fuel cell comprising the catalyst layer of one or more embodiments disclosed and described herein, and it is also a schematic view of a section cut in the laminating direction;

FIG. 2 is a graph showing the results of a power generation test of the membrane electrode assemblies of Examples 1 and 3 and Comparative Examples 1 and 2;

FIG. 3 is a graph showing the results of a power generation test of the membrane electrode assemblies of Examples 2, 4 and 5 and Reference Example 1, at a relative humidity of 30%;

FIG. 4 is a graph showing the results of a power generation test of the membrane electrode assemblies of Examples 2, 4 and 5 and Reference Example 1, at a relative humidity of 80%;

FIG. 5 is a bar chart comparing a current value at 0.1 V on the IV curve of Example 2 and a current value at 0.1 V on the IV curve of Reference Example 1;

FIG. 6 is a photograph of an anode catalyst layer formed with a catalyst ink used in Example 2 and an anode catalyst layer formed with a catalyst ink used in Comparative Example 3;

FIG. 7 is a graph showing the IV curve of the membrane electrode assembly of Example 2 along with the IV curve of the membrane electrode assembly of Comparative Example 4;

FIG. 8 is a graph showing a change in cell resistance of the membrane electrode assembly of Example 2 along with a change in cell resistance of the membrane electrode assembly of Comparative Example 4;

FIG. 9 is a graph showing a relationship between the composition and electrical resistance of TiOₓ;

FIG. 10(a) is a schematic sectional view of a catalyst composite 22 that is relatively large in particle diameter and covered with an ionomer 21;

FIG. 10(b) is a schematic sectional view of a catalyst composite 23 that is relatively small in particle diameter and covered with the ionomer 21; and

FIG. 11 is a graph showing a moisture sorption-desorption curve of a titanium oxide support along with a moisture sorption-desorption curve of a carbon support.

### DETAILED DESCRIPTION

The method for producing the fuel cell catalyst layer according to one or more embodiments disclosed and described herein, comprises the steps of: preparing a catalyst composite that comprises a titanium oxide support and platinum or a platinum alloy supported on a surface thereof, the titanium oxide support comprising Ti₄O₇ as a main component, and an ionomer that is a proton-conductive polymer; mixing the catalyst composite, the ionomer, and a dispersion medium containing at least water and a tertiary alcohol having from 4 to 6 carbon atoms where a content ratio of the tertiary alcohol is the highest, in such conditions that a ratio (I/MO) of a mass (I) of the ionomer to a mass (MO) of the titanium oxide support is in a range of from 0.12 to 0.16, and a content of a solid comprising the catalyst composite and the ionomer is 24 mass % or more; and, while pulverizing aggregates comprising the catalyst composite and the ionomer by use of at least one medium selected from the group consisting of a gas, a liquid, and a solid having a Vickers hardness lower than titania, dispersing a mixture obtained by the pulverization in the dispersion medium.

Hereinafter, the steps of the production method of the one or more embodiments disclosed and described herein, will be described in order.

### 1. Preparing Step

First, the catalyst composite and the ionomer are prepared. The catalyst composite comprises a titanium oxide support and platinum or a platinum alloy supported on a surface thereof. The ionomer is a proton-conductive polymer. These materials will be described in order.

### (1) Titanium Oxide Support

The titanium oxide represented by the chemical formula TiOₓ (where x>0) is resistant to deterioration in a condition where a fuel cell is being operated. Therefore, the titanium oxide is promising as an alternative material for the catalyst layer to a carbon support. However, since the electrical resistance of the titanium oxide largely varies depending on an oxygen ratio x, it cannot be said that titanium oxides are all usable as a material for the catalyst layer.

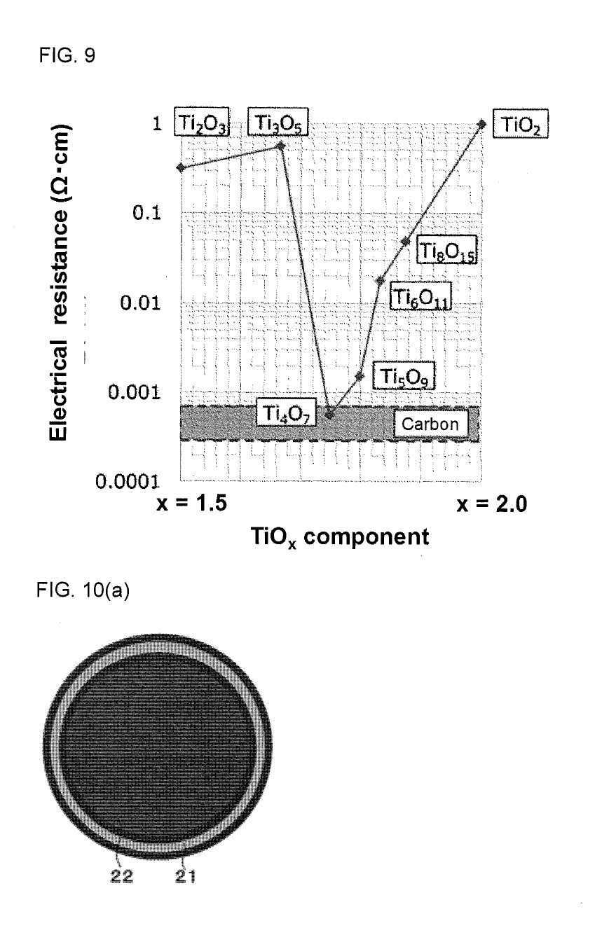

FIG. 9 is a graph showing a relationship between the composition and electrical resistance of TiOₓ. FIG. 9 is also a graph with the natural log of an electrical resistance (Ω·cm) on the vertical axis and the oxygen ratio x on the horizontal axis. In FIG. 9, the electrical resistance value is a value obtained by actually measuring the electrical resistance of each TiOₓ single crystal. Also in FIG. 9, a part indicated by dashed lines (3×10⁻⁴ to 7×10⁻⁴ (Ω·cm)) indicates the range of electrical resistance of carbon.

As is clear from FIG. 9, both the electrical resistance of Ti₂O₃ (x=1.50) and that of Ti₃O₅ (x=1.67) are 0.3 (Ω·cm) or more and high. Meanwhile, the electrical resistance of Ti₄O₇ (x=1.75) is less than 6×10⁻⁴ (Ω·cm) and is the smallest value in FIG. 9. This is because the crystal structure of the titanium oxide includes many oxygen defects when the oxygen ratio x is 1.75. This electrical resistance value is at the same level as the electrical resistance value of carbon.

However, when the oxygen ratio x increases to more than 1.75, the oxygen defects are gradually filled with oxygen atoms. As a result, the electrical resistance gradually increases, and the electrical resistance of TiO₂ (x=2.00) is 1 (Ω·cm). Since the electrical resistance of the TiO₂ is too high, the TiO₂ is poor in electroconductivity and, as a result, is not usable as a material for the catalyst layer.

As just described, there is a correlation between the oxygen defects and electroconductivity of the titanium oxide. That is, at an oxygen ratio with a small number of oxygen defects (x=1.50 to 1.67, 2.00), the electrical resistance of the titanium oxide is high and results in low electroconductivity. On the other hand, at an oxygen ratio with the largest number of oxygen defects (x=1.75), the electrical resistance of the titanium oxide (Ti₄O₇) is the lowest and results in the highest electroconductivity. As the composition of the titanium oxide gets closer to Ti₄O₇, the electrical resistance value of the titanium oxide gets closer to the electrical resistance value of carbon.

The electrical resistance value varies depending on the physical properties of the titanium oxide, such as crystallinity and particle size. Even if the physical properties of the titanium oxide remain the same, the electrical resistance value may be varied depending on the condition of resistance measurement, for example, by changing the magnitude of a pressure applied to single crystal. However, regardless of the physical properties of the titanium oxide or the condition of the resistance measurement, there is no change in the tendency of the electrical resistance value to be the smallest when, as shown in FIG. 9, the oxygen ratio x is 1.75.

The titanium oxide support used in the production method of the one or more embodiments disclosed and described herein, comprises Ti₄O₇ as a main component. That is, Ti₄O₇ accounts for 50 mass % or more of the titanium oxide support. In the case of using such a titanium oxide support that the surface and inside differ in composition, at least 50 mass % of Ti₄O₇ may be contained on the surface of the titanium oxide support.

Ti₄O₇ is a compound that has the most reduced Magneli phase among titanium oxides. Therefore, the titanium oxide support comprising Ti₄O₇ as a main component, is such a titanium oxide support that the most reduced Magneli phase accounts for 50 mass % or more of the titanium oxide support. In the case of using such a titanium oxide support that the surface and inside differ in composition, at least 50 mass % or more of the most reduced Magneli phase may be contained on the surface of the titanium oxide support.

In general, the Magneli phase of a titanium oxide basically has a rutile-type crystal structure in which TiO₂ octahedral blocks are arranged in a matrix in a plane. However, the rutile-type crystal structure of the Magneli phase lacks one or more oxygen atoms. The crystal structure of the Magneli phase of the titanium oxide is triclinic. The Magneli phase has shear planes derived from oxygen defects.

The Magneli phase of Ti₄O₇ lacks one oxygen atom per four TiO₂ octahedral blocks. This corresponds to removal of one oxygen atom from four TiO₂'s (TiO₂×4−O=Ti₄O₇).

Among titanium oxides having a Magneli phase, Ti₄O₇ has the largest number of oxygen defects; therefore, it has the most reduced Magneli phase, the largest number of shear planes, the shortest distance between the shear planes, and the best electroconductivity. Therefore, the titanium oxide support comprising Ti₄O₇ as a main component, has many oxygen defects and, as a result, it has low electrical resistance and provides excellent electroconductivity as a support.

A known method can be used to confirm whether the titanium oxide support comprises Ti₄O₇ as a main component or not.

For example, in the case of confirming the Ti₄O₇ content ratio by an XRD spectrum, it can be confirmed from the ratio of the intensity of a known XRD peak belonging to Ti₄O₇ to the intensity of a known XRD peak belonging to other TiOₓ (e.g., TiO₂).

The Ti₄O₇ content ratio can be also confirmed by electrical resistance measurement. For example, TiO₂ and Ti₄O₇ are taken as reference materials and measured for their electrical resistances. Then, the electrical resistance of a sample titanium oxide support is measured. From these electrical resistance values, the Ti₄O₇ content ratio is calculated. However, since a generated grain boundary resistance varies depending on the state (such as crystallinity or particle size) of a substance used for the electrical resistance measurement, it is necessary to bring the state of the reference material and the state of the sample substance close to each other as much as possible.

The titanium oxide support used in the production method of the one or more embodiments disclosed and described herein, is not particularly limited, as long as it comprises Ti₄O₇ as a main component, and the surface and inside of the titanium oxide support may differ in composition.

As just described, by the use of the titanium oxide support with excellent electroconductivity, the same level of electroconductivity as that of the case of using a carbon support, can be attained.

The average particle diameter of the titanium oxide support is not particularly limited, as long as it is in a range that is practically applicable to fuel cell catalyst layers. However, when the particle diameter of the titanium oxide support is too small compared to the particle diameter of the platinum particles or platinum alloy particles, it may be difficult to support the platinum particles or platinum alloy particles. When the particle diameter of the titanium oxide support is too large, the volume of the catalyst composite increases to increase the thickness of the catalyst layer too much. Therefore, a decrease in power generation performance may occur. Accordingly, the average particle diameter of the titanium oxide support is preferably in a range of from 7.5 to 50 nm, more preferably in a range of from 20 to 30 nm, and still more preferably in a range of from 22 to 28 nm. Also in the one or more embodiments disclosed and described herein, the average particle diameter is determined by observing the particles of the titanium oxide support with a transmission electron microscope (TEM) at a magnification of 250000×, measuring the particle diameters of about 250 of the visually confirmed particles on the assumption that the particles are spherical, and determining the average of the particle diameters as the average particle diameter.

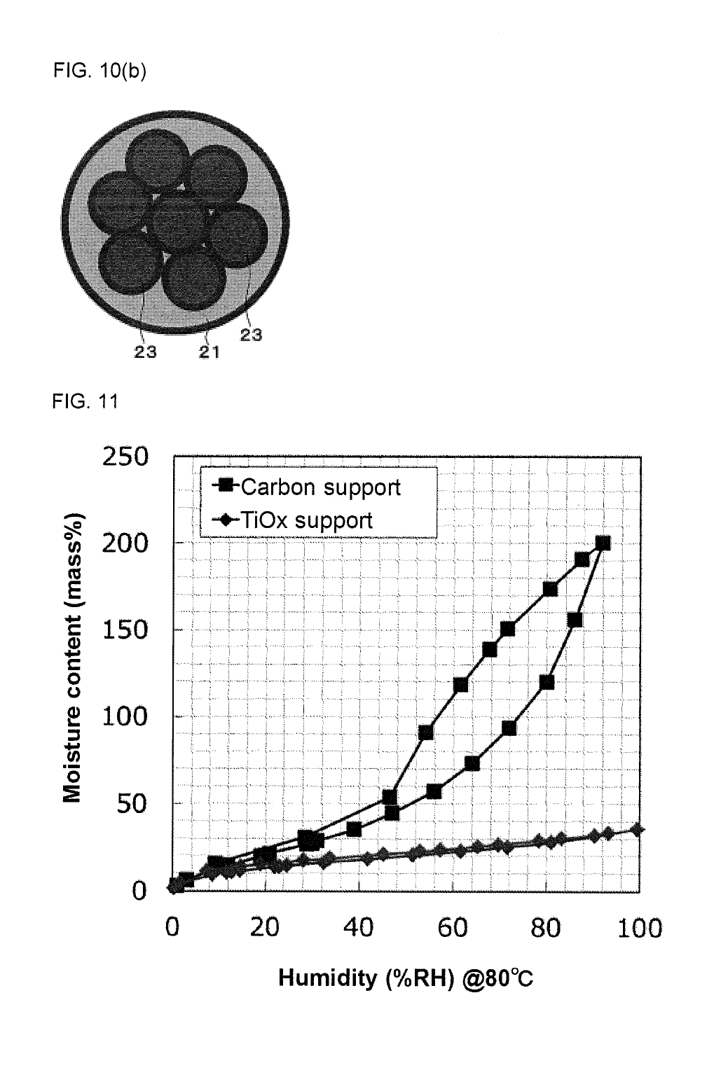

FIG. 10(a) is a schematic sectional view of a catalyst composite 22 that is relatively large in particle diameter and covered with an ionomer 21. FIG. 10(b) is a schematic sectional view of a catalyst composite 23 that is relatively small in particle diameter and covered with the ionomer 21. As shown in FIG. 10(a), each primary particle of the catalyst composite may be covered as it is with the ionomer. Meanwhile, as shown in FIG. 10(b), in the average particle diameter range that is practically applicable to the fuel cell catalyst layer, secondary particles, each of which is composed of primary particles, may be formed by the catalyst composite in the catalyst ink. Each of the secondary particles thus formed may be covered with the ionomer. However, regardless of the particle diameters of the primary particles, the sizes of the secondary particles are almost the same (the surface areas of the secondary particles per volume of the titanium oxide support are almost the same) and the distance between the primary particles in each secondary particle is quite small. Therefore, the amount of the ionomer present between the primary particles (i.e., inside each secondary particle) is quite small. Due to this reason, even if the average particle diameter of the titanium oxide support (primary particles) in the catalyst composite differs, there is no change in the optimal ionomer volume for covering the titanium oxide support having a fixed volume.

### (2) Catalyst Composite

As the shape of the platinum or platinum alloy in the catalyst composite, examples include, but are not limited to, particle shapes such as a spherical shape and an oval spherical shape. The average particle diameter is preferably in a range of from 3 to 10 nm, for example.

The amount of the platinum or platinum alloy supported on the surface of the titanium oxide support is not particularly limited. In general, the mass support ratio of the platinum or platinum alloy with respect to the catalyst composite is in a range of from 5 to 20 mass %. The mass support ratio can be obtained by the following formula (1):

Mass support ratio (%)=the mass of the catalyst/(the mass of the catalyst+the mass of the titanium oxide support)×100 Formula (1)

### (3) Ionomer

The ionomer used in the production method of the one or more embodiments disclosed and described herein, is not particularly limited, as long as it is a proton-conductive polymer. As the ionomer, examples include, but are not limited to, Nafion (trademark, manufactured by DuPont). Nafion is a perfluorocarbon composed of a hydrophobic Teflon™ framework, which is composed of a carbon-fluorine bond, and a perfluorocarbon side chain, which includes a sulfonic acid group.

In general, ionomers that are practically applicable to the fuel cell catalyst layer, are similar in basic molecular structure, even if they are different types of ionomers. Accordingly, the polymer density is in a range of from 1.9 to 2.0 g/cm³. As described above, there is no change in the optimal ionomer volume required for covering the titanium oxide support having a fixed mass. Therefore, even if the type of the ionomer changes, there is no change in the optimal ionomer mass required for covering the titanium oxide support having a fixed mass. Therefore, the type of the ionomer has no influence on the range of the ratio (I/MO). The polymer density can be calculated by producing a film having a uniform thickness and measuring the mass and volume of the film. However, since the polymer is an electrolyte and the apparent size varies depending on its moisture state, it is necessary to measure the mass and volume when the polymer is in a dry state.

In general, as the average molecular weight of the ionomer increases, the solubility decreases. On the other hand, as the average particle diameter decreases, the ionomer becomes friable. Therefore, the average molecular weight is generally in a range of from 10,000 to 200,000, preferably in a range of from 100,000 to 200,000, and more preferably in a range of from 150,000 to 200,000.

The ionomer is not limited to the above examples and may be a common ionomer.

### 2. Mixing Step

This is the step of mixing the catalyst composite, the ionomer, and the specific dispersion medium in such conditions that the ratio (I/MO) of the mass (I) of the ionomer to the mass (MO) of the titanium oxide support is in a range of from 0.12 to 0.16, and the content of the solid comprising the catalyst composite and the ionomer is 24 mass % or more.

A major point of the one or more embodiments disclosed and described herein, is that in the case of using the titanium oxide support, the mixing and dispersing conditions differ from the case of using a carbon support.

### (1) The Ratio (I/MO) of the Mass (I) of the Ionomer to the Mass (MO) of the Titanium Oxide Support

In the mixing step of the one or more embodiments disclosed and described herein, the ratio (I/MO) of the mass (I) of the ionomer to the mass (MO) of the titanium oxide support is in a range of from 0.12 to 0.16, in order to obtain the fuel cell catalyst layer that is configured to be usable in a wide range of humidity environments and provide excellent IV characteristic.

In general, when the ionomer amount is too small compared to the electroconductive support in the catalyst ink, the catalyst and the electroconductive support cannot be sufficiently covered with the ionomer, so that they cannot adapt to changes in the relative humidity of an external environment. On the other hand, when the ionomer amount is too large compared to the electroconductive support in the catalyst ink, the thickness of the ionomer layer covering the catalyst and the electroconductive support, increases to increase the resistance of the fuel cell catalyst layer thus produced. Therefore, the compositional ratio of the electroconductive support and the ionomer has an appropriate range.

FIG. 11 is a graph showing the moisture sorption-desorption curve of the titanium oxide support along with the moisture sorption-desorption curve of the carbon support. In FIG. 11, diamonds indicate the data of the titanium oxide support, and squares indicate the data of the carbon support. For the carbon support data shown in FIG. 11, the lower portion is a moisture sorption curve showing a change in moisture content when the humidity of the environment is increased; meanwhile, the upper portion is a moisture desorption curve showing a change in moisture content when the humidity of the environment is decreased.

As is clear from FIG. 11, for the carbon support, when compared at the same humidity, the moisture content is larger on the moisture sorption curve than on the moisture desorption curve. Therefore, hysteresis occurs in the carbon support during moisture sorption and desorption. The hysteresis indicates such a property that the carbon support does not sorb excess moisture when the humidity is increased, and it easily retains moisture when the humidity is decreased. For the titanium oxide support, the moisture content is lower than carbon support in all humidity conditions, and unlike the carbon support, hysteresis does not occur. As just described, the titanium oxide support and the carbon support differ in moisture retention property. More specifically, while the carbon support easily receives water, the titanium oxide support poorly receives water. From the difference in moisture retention property, it can be said that the titanium oxide support is more sensitive to humidity changes than the carbon support, and the ionomer-covered state is more important to the titanium oxide support than the carbon support. This means that the titanium oxide support cannot respond to humidity changes, without controlling the ratio (I/MO) more sensitively than the case of using the carbon support.

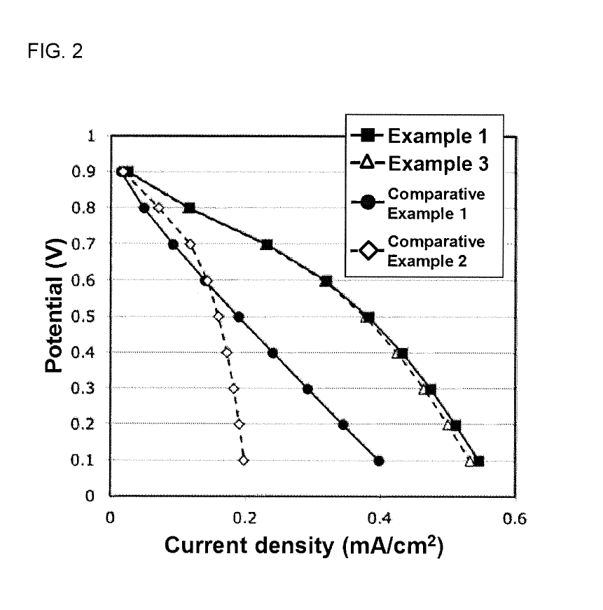

As described above, the titanium oxide support more easily sorbs and desorbs moisture than the carbon support. Therefore, when the ratio (I/MO) is less than 0.12 or is more than 0.16, the ionomer amount is not appropriate and results in a decrease in IV characteristic. This fact will be proved by Comparative Examples 1 and 2 described below (see Table 1 and FIG. 2).

As described above, the optimal ionomer volume required for covering the titanium oxide support having a fixed mass, is not influenced by the average particle diameter and shape of the titanium oxide support, the type of the ionomer, etc. Therefore, due to the use of the titanium oxide support and the ionomer, the fuel cell catalyst layer that is usable in a wide range of humidity environments and provides excellent IV characteristic, can be obtained by controlling the ratio (I/MO) in a range of from 0.12 to 0.16.

The ratio (I/MO) is preferably in a range of from 0.14 to 0.16, since excellent power generation performance can be obtained in a wide range of humidity environments. From the viewpoint of practical applications, there is no need to install a humidifier or the like to supply a gas with a controlled relative humidity to a fuel cell electrode; therefore, a simplification of a fuel cell system can be achieved.

### (2) Solid Content

In this step, the content of the solid comprising the catalyst composite and the ionomer is 24 mass % or more. In a conventional catalyst ink comprising a carbon support, the solid content is generally about 3 mass %. In this step, the solid content is much larger than the conventional solid content.

As described above, in the production method according to the one or more embodiments in which the titanium oxide support is used, in order to obtain the catalyst layer with desired performance, the mass of the ionomer with respect to the mass of the titanium oxide support, needs to be smaller than the case of using the carbon support. As a result, in the production method according to the one or more embodiments, the content of the ionomer in the solid comprising the catalyst composite and the ionomer, is smaller than the case of using the carbon support.

Therefore, even if the solid content of the catalyst ink comprising the titanium oxide support is the same as the catalyst ink comprising the carbon support, compared to the catalyst ink comprising the carbon support, the catalyst ink comprising the titanium oxide support is smaller in the absolute amount of the ionomer that contributes to the formation of a higher-order structure, and obtains low viscosity.

However, the specific gravity of the titanium oxide support is higher than the carbon support, and high viscosity is needed to uniformly disperse the catalyst composite comprising the titanium oxide support in the catalyst ink. Therefore, if the catalyst ink has low viscosity, the coatability of the catalyst ink deteriorates and poses such a new problem that an even and transferable catalyst layer cannot be formed by a casting method, for example.

Therefore, in the one or more embodiments in which the titanium oxide support is used, by controlling the solid content to 24 mass % or more and thereby increasing the viscosity of the catalyst ink, the coatability of the catalyst ink is increased, and the even and transferable catalyst layer can be formed.

The upper limit of the solid content is not particularly limited. To uniformly disperse the catalyst composite and the ionomer in the catalyst ink, the upper limit is preferably 40 mass % or less, and more preferably 30 mass % or less.

### (3) Dispersion Medium

The dispersion medium used in the production method of the one or more embodiments disclosed and described herein, is not particularly limited, as long as it contains at least water and the tertiary alcohol having from 4 to 6 carbon atoms where the content ratio of the tertiary alcohol is the highest.

In general, the composition of the dispersion medium used for the catalyst ink has a large influence on the dispersibility of the electroconductive support and ionomer, the performance of the catalyst layer to be obtained, etc. Therefore, the composition of the dispersion medium needs to be appropriately controlled depending on the type of the electroconductive support and ionomer used.

In the case of using the titanium oxide support, it is important that the dispersion medium does not have a negative influence that can change the chemical composition of the titanium oxide support. If the chemical composition of the titanium oxide support is changed, as described above regarding FIG. 9, oxygen defects decrease. As a result, the electrical resistance of the titanium oxide support increases to remarkably decrease the IV characteristic.

Like the production method of the one or more embodiments disclosed and described herein, especially in the case of using alcohol, there is a possibility that the alcohol serves as a reducing agent to reduce and chemically deteriorate the titanium oxide support. In the one or more embodiments disclosed and described herein, therefore, primary or secondary alcohol, which has high reducing power, is avoided and tertiary alcohol is used. Alcohol having a too large carbon number is unfit for ink preparation, since it is in the form of a solid or in the form of a solution that has poor compatibility with water. Therefore, the tertiary alcohol having from 4 to 6 carbon atoms is used in the production method of the one or more embodiments disclosed and described herein.

As the tertiary alcohol having from 4 to 6 carbon atoms, examples include, but are not limited to, t-butyl alcohol, t-pentyl alcohol, 3-hydroxy-3-methyl-2-butanone, t-hexyl alcohol, 3-methylpentane-3-ol, diacetone alcohol, 2-hydroxy-2-methyl-3-pentanone, and 3-hydroxy-3-methyl-2-pentanone. Of them, from the viewpoint of low reducing power, at least any one of diacetone alcohol and t-butyl alcohol is preferably used.

The compositional ratio of the dispersion medium is not particularly limited, as long as the content ratio of the tertiary alcohol is the highest. However, when the dispersion medium contains many types of liquids and the content ratio of the tertiary alcohol is relatively too low, the titanium oxide support may be chemically deteriorated by the action of other liquids in the dispersion medium. Therefore, the content ratio of the tertiary alcohol in the dispersion medium is preferably 20 mass % or more, more preferably 30 mass % or more, and still more preferably 40 mass % or more.

### 3. Dispersing Step

This is the step of, while pulverizing the aggregates comprising the catalyst composite and the ionomer by use of the specific medium, dispersing the mixture obtained by the pulverization in the dispersion medium.

As described above, if the solid content in the catalyst ink is increased to 24% or more for better coatability, aggregates comprising the titanium oxide support and the ionomer are likely to be produced. Therefore, to uniformly disperse the catalyst composite and the ionomer in the catalyst ink, it is preferable to prevent reaggregation of the mixture obtained by the pulverization.

On the other hand, to prevent changes in the properties of the titanium oxide support as much as possible, a relatively mild dispersing method and a medium are used in this step.

In the case of using the titanium oxide support in this step, it is important to avoid physical damage to the titanium oxide support in this step. If the titanium oxide support is damaged, as described above regarding FIG. 9, oxygen defects decrease. As a result, the electrical resistance of the titanium oxide support increases to remarkably decrease the IV characteristic.

In this step, to avoid damage to the titanium oxide support and uniformly disperse the catalyst composite and the ionomer, the medium used for the dispersion is a soft material. The reason is as follows: if a medium that is as hard as the titanium oxide support is used, the medium and the titanium oxide support collide with each other and result in a change in the composition of the titanium oxide support.

In this step, a gas, a liquid, and a solid having a Vickers hardness lower than titania, are used as the medium. By the use of the media that are softer than titania in the dispersion, the titanium oxide support can be uniformly dispersed without damage thereto.

As the gas that serves as the medium in the dispersion, examples include, but are not limited to, bubbles that are generated in the dispersion medium. As the dispersion method that uses the gas as the medium, examples include, but are not limited to, an ultrasonic homogenizer described below. In the case of using the ultrasonic homogenizer, ultrasonic vibration is applied to the mixture; therefore, microbubbles are generated by pressure difference, serve as the medium and repeatedly apply an impact force to the mixture.

As the liquid that serves as the medium in the dispersion, examples include, but are not limited to, the above-described dispersion medium (mixed solvent) used in the mixing step. As the dispersion method that uses the liquid as the medium, examples include, but are not limited to, the above-described ultrasonic homogenizer. In the case of using the ultrasonic homogenizer, ultrasonic waves directly reach the mixture through the liquid and repeatedly apply an impact force to the mixture.

The solid that serves as the medium in the dispersion, needs to have a Vickers hardness lower than titania. As used herein, “Vickers hardness” is an indicator of hardness defined in 3.1 in ISO 14705:2008 or 3a) in JISR 1610:2003. A Vickers hardness test can be carried out in conformity to 4.6 in ISO 14705:2008 or 4.6 in JISR 1610:2003.

The Vickers hardness of titania depends on crystal structure or purity; however, it is generally in a range of from 7.5 GPa to 8.8 GPa. Accordingly, when the solid is used as the medium in this step, the Vickers hardness needs to be less than 7.5 GPa. The solid is preferably a solid having a Vickers hardness of 6.0 GPa or less, and more preferably a solid having a Vickers hardness of 5.0 GPa or less.

The Vickers hardness test is a so-called indentation hardness test. As defined in ISO 14705:2008 and JISR 1610:2003, Vickers hardness is a value obtained by dividing an indentation test force by the surface area of an indentation produced on the surface of a sample by an indenter, and then multiplying the resultant by a constant. Accordingly, for a too soft sample, there is a possibility that the surface area of the indentation cannot be measured, and the Vickers hardness cannot be calculated. Solid materials that are clearly softer than titania, are considered to include such a material for which the Vickers hardness cannot be calculated. In the one or more embodiments disclosed and described herein, such a solid material that is too soft to calculate the Vickers hardness, is determined to have a Vickers hardness of 0 GPa.

As the material for the solid medium used in the dispersion, examples include, but are not limited to, the following materials. Values in parentheses are each a Vickers hardness (a reference value).

Aluminum (0.50 GPa), copper (0.80 GPa), boron nitride (0.80 GPa), silver (0.88 GPa), nickel (0.90 GPa), molybdenum-copper alloy (1.7 GPa), stainless steel (SUS304) (2.0 GPa), iron (2.5 GPa), molybdenum (2.6 GPa), tungsten-copper alloy (3.0 GPa), tungsten (4.2 GPa)

The solid medium used in the dispersion may be a device for pulverizing aggregates or may be a part of the device. In this case, the solid medium is not particularly limited, as long as it has a shape or structure that allows the solid medium to be in contact with and pulverize aggregates in the dispersion. As the solid medium, examples include, but are not limited to, the rotor blade or stator inner wall of a high-shear mixer.

In this step, a solid material that is clearly softer than titania can be used as the dispersion medium, even when the Vickers hardness is not clear. As the solid material, examples include, but are not limited to, commodity plastics such as polyethylene, polypropylene and polystyrene; engineering plastics such as polyether ether ketone, polyether ketone and polyethersulfone; and various kinds of functional polymers such as Nafion (trademark, manufactured by DuPont).

In the dispersion, a combination of two or more kinds of the gas, liquid and solid may be used as the medium. For instance, the above-described ultrasonic homogenizer is an example of a combination of bubbles and the liquid. As the dispersion medium that is a combination of the liquid and the solid, examples include, but are not limited to, a slurry medium.

As the device for pulverizing aggregates, examples include, but are not limited to, a high-shear mixer and an ultrasonic homogenizer. For the high-shear mixer, the pulverizing force is higher than the ultrasonic homogenizer, and the power of rubbing the ionomer into the catalyst composite surface, is also higher than the ultrasonic homogenizer. However, the titanium oxide support itself cannot be pulverized by any of the high-shear mixer and the ultrasonic homogenizer.

Therefore, the high-shear mixer or the ultrasonic homogenizer is preferably used in this step.

The high-shear mixer is a device for applying shear force by use of a centrifugal force of pushing the contents against the inner wall of the stator and a force derived from a rotating flow produced by the rotor blade.

The ultrasonic homogenizer is a device for applying ultrasonic vibration to a solution, generating microbubbles due to the resulting pressure difference, and repeatedly applying an impact force to substances in the solution.

The dispersion time is not particularly limited. It is preferably 15 minutes or more, more preferably 3 hours or more, and still more preferably 6 hours or more.

By employing the above-described dispersion method and medium, the catalyst layer can be formed with maintaining the composition of the Ti₄O₇, which has small electrical resistance.

### 4. Other Steps

The production method of the one or more embodiments disclosed and described herein, may comprise the step of forming a catalyst layer on a surface of an electrolyte membrane by at least one method selected from the group consisting of a casting method, a screen printing method, a doctor blade method, a gravure printing method and a die coating method.

The casting method is a method for applying a coating material to a surface of a flat substrate having a given area. The screen printing method, the doctor blade method, the gravure printing method and the die coating method are conventionally known methods.

These applying methods are preferred due to excellent coatability even when, like the production method of the present invention, the solid content of a catalyst ink is high. There applying methods are also preferred since they are high in production rate and large in yield.

### 5. Fuel Cell Catalyst Layer

The fuel cell catalyst layer obtained by the production method of the one or more embodiments disclosed and described herein, contains the catalyst composite comprising the titanium oxide support and the platinum or platinum alloy supported on the surface thereof, and the ionomer covering the catalyst composite. Since the ratio (I/MO) is in a range of from 0.12 to 0.16, the fuel cell catalyst layer can prevent an increase in cell resistance and provide excellent IV characteristic when it is used in a fuel cell.

The fuel cell catalyst layer is preferably a fuel cell catalyst layer for an anode. This is because the titanium oxide support is particularly chemically stable in a reducing atmosphere.

The properties of the fuel cell catalyst layer are different between the anode and the cathode. In a fuel cell, hydrogen diffuse faster than oxidant gas such as oxygen. Therefore, even when the ratio (I/MO) is high, the influence of the ratio (I/MO) on gas diffusion is small. As a result, the performance under a dry condition of the anode can be increased by using the fuel cell catalyst layer in the anode.

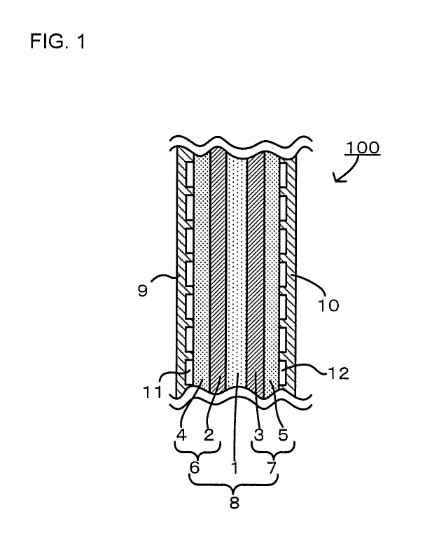

FIG. 1 is a view of an example of a fuel cell comprising the catalyst layer obtained by the production method of the one or more embodiments disclosed and described herein, and it is also a schematic view of a section cut in the laminating direction. A membrane electrode assembly 8 comprises a polyelectrolyte membrane (hereinafter it may be simply referred to as “electrolyte membrane”) 1, which is a hydrogen ion conductive polyelectrolyte membrane, and a pair of a cathode 6 and an anode 7, between which the electrolyte membrane 1 is sandwiched. A fuel cell (single cell) 100 comprises the membrane electrode assembly 8 and a pair of separators 9 and 10, between which the membrane electrode 8 is sandwiched through the outside of the electrodes. An oxidant gas channel 11 is disposed at the boundary of the separator 9 and the cathode 6, and a fuel gas channel 12 is disposed at the boundary of the separator 10 and the anode 7. In general, a stack of a catalyst layer and a gas diffusion layer is used as an electrode, in which the catalyst layer and the gas diffusion layer are stacked in this sequence from the electrolyte membrane side. In particular, the cathode 6 is a stack of a cathode catalyst layer 2 and a gas diffusion layer 4, and the anode 7 is a stack of an anode catalyst layer 3 and a gas diffusion layer 5.

At least any one of the anode and the cathode includes the catalyst layer obtained by the production method of the one or more embodiments disclosed and described herein. As described above, the catalyst layer is preferably used in the anode.

As the electrolyte membrane, gas diffusion layers and separators used in the fuel cell, those that are generally used in a fuel cell are used.

### EXAMPLES

The production method of the one or more embodiments disclosed and described herein, will be further clarified by the following examples and comparative examples. However, the production method is not limited to the following examples and comparative examples.

### 1. Production of Membrane Electrode Assembly

### Example 1

### (1) Preparing Step

Such a catalyst composite was prepared, that the mass support ratio of platinum supported on the surface of a titanium oxide support comprising Ti₄O₇ as a main component (manufactured by Sakai Chemical Industry Co., Ltd.) was 15 mass %. Also, an ionomer dispersion having dispersed therein 10% ionomer A, was prepared.

The ionomer A is a perfluorocarbon sulfonic acid polymer that has a polymer density of 1.9 g/cm² and is classified as Nafion™ (manufactured by DuPont)-based fluorinated sulfonic acid polymer.

The dispersion medium of the ionomer dispersion is a mixed solution of water, diacetone alcohol and ethanol at a ratio of 42 (mass %):45 (mass %):13 (mass %).

### (2) Mixing Step

The catalyst composite, the ionomer dispersion and a dispersion medium were mixed so that the ratio (I/MO) of the mass (I) of the ionomer A to the mass (MO) of the titanium oxide support was 0.16 and the content of a solid comprising the catalyst composite and the ionomer was 24 mass %. The composition of the dispersion medium used in the mixing step is the same as the composition of the dispersion medium of the ionomer dispersion.

### (3) Dispersing Step

The mixture obtained by the mixing step was dispersed at a rotational frequency of 20,000 rpm for 15 minutes by use of a high-shear mixer (product name: ULTRA-TURRAX T8, manufactured by: IKA), thereby preparing a catalyst ink.

Of the components of the high-shear mixer, those that were in contact with the mixture in the dispersion are the rotor blade and stator inner wall of the high-shear mixer. These components were made of SUS304 (Vickers hardness: 2.0 GPa).

### (4) Production of Membrane Electrode Assembly

The catalyst ink was applied on a polytetrafluoroethylene (PTFE) sheet by a casting method so that the platinum amount was 0.05 mg per 1 cm² area of the catalyst layer. The applied catalyst ink was naturally dried. The PTFE sheet was cut into a 1 cm square piece and used as an anode catalyst layer.

Meanwhile, a catalyst was prepared as a cathode catalyst layer, the catalyst comprising an acetylene black (AB) support and a platinum-cobalt alloy supported thereon (PtCo/AB, platinum supporting rate: 50 mass %, average particle diameter: 4 nm, Pt:Co=7:1, catalyst basis weight: 0.1 mg/cm²)

The anode catalyst layer was disposed on one side of an electrolyte membrane (Nafion™ membrane manufactured by DuPont, thickness 50 μm) and the cathode catalyst layer was disposed on the other side of the electrolyte membrane. Then, they were attached by pressing them at 3 MPa and 140° C. for 4 minutes, thereby producing a membrane electrode assembly (Example 1).

### Examples 2 to 5 and Comparative Examples 1 to 3

Membrane electrode assemblies of Examples 2 to 5 and Comparative Examples 1 to 3 were produced in the same manner as Example 1, except that the conditions of the anode catalyst layer, the cathode catalyst layer and the electrolyte membrane were changed as shown Table 1.

### Comparative Example 4

### (1) Preparing Step

A catalyst composite and an ionomer dispersion having dispersed therein 10% ionomer A, were prepared in the same manner as Example 1.

The ionomer A is the same polymer as the one used in Example 1.

The dispersion medium of the ionomer dispersion is a mixed solution of water and ethanol at a ratio of 50 (mass %):50 (mass %)

After the preparing step, (2) the mixing step was carried out in the same manner as Example 1.

### (3) Dispersing Step

The mixture obtained by the mixing step was dispersed at 300 rpm for 6 hours by use of a planetary ball mill (product name: PM200; manufactured by: Retsch), thereby preparing a catalyst ink.

Of the components of the ball mill, those that were in contact with the mixture in the dispersion are balls and a mill pod. These components were made of zirconia (Vickers hardness: 12.5 GPa).

### (4) Production of Membrane Electrode Assembly

Using the catalyst ink, an anode catalyst layer was formed in the same manner as Example 1.

A catalyst was prepared as a cathode catalyst layer, the catalyst comprising an acetylene black (AB) support and a platinum-cobalt alloy supported thereon (PtCo/AB, platinum supporting rate: 50 mass %, average particle diameter: 4 nm, Pt:Co=7:1, catalyst basis weight: 0.4 mg/cm²)

The anode catalyst layer was disposed on one side of an electrolyte membrane (Nafion™ membrane manufactured by DuPont, thickness 10 μm) and the cathode catalyst layer was disposed on the other side of the electrolyte membrane. Then, they were attached by pressing them at 3 MPa and 140° C. for 4 minutes, thereby producing a membrane electrode assembly (Comparative Example 4).

### Reference Example 1

### (1) Preparing Step

Such a catalyst composite was prepared, that the mass support ratio of platinum supported on the surface of a carbon support (Ketjen Black™ manufactured by Ketjen Black International Company) was 15 mass %. Also, an ionomer dispersion having dispersed therein 10% ionomer A, was prepared.

The ionomer A is the same polymer as the one used in Example 1.

The dispersion medium of the ionomer dispersion is a mixed solution of water and ethanol at a ratio of 50 (mass %):50 (mass %).

### (2) Mixing Step

The catalyst composite, the ionomer dispersion and a dispersion medium were mixed so that the ratio (I/MO) of the mass (I) of the ionomer A to the mass (MO) of the titanium oxide support was 1.2 and the content of the solid comprising the catalyst composite and the ionomer A was 3 mass %. The composition of the dispersion medium used in the mixing step is the same as the composition of the dispersion medium of the above-described ionomer dispersion.

After the mixing step, the dispersing step was carried out in the same manner as Example 1 to form an anode catalyst layer.

A catalyst was prepared as a cathode catalyst layer, the catalyst comprising an acetylene black (AB) support and a platinum-cobalt alloy supported thereon (PtCo/AB, platinum supporting rate: 50 mass %, average particle diameter: 4 nm, Pt:Co=7:1, catalyst basis weight: 0.4 mg/cm²).

The anode catalyst layer was disposed on one side of an electrolyte membrane (Nafion™ membrane manufactured by DuPont, thickness 10 μm) and the cathode catalyst layer was disposed on the other side of the electrolyte membrane. Then, they were attached by pressing them at 3 MPa and 140° C. for 4 minutes, thereby producing a membrane electrode assembly (Reference Example 1).

The following Table 1 shows the conditions of the anode catalyst layer, cathode catalyst layer and electrolyte membrane of the above-described membrane electrode assemblies. In Table 1, “TiOₓ” means titanium oxide support; “C” means carbon support; “DAA” means diacetone alcohol; “HSM” means high-shear mixer; and “BM” means planetary ball mill.

TABLE 1

| | Anode catalyst layer | | | | | | | | | | |
|---|---|---|---|---|---|---|---|---|---|---|---|
| | | | | Main | | | | | | Cathode | |
| | | | | component | | | | Dispersing condition | | catalyst layer | Electrolyte |
| | | | Solid | of | Composition of dispersion | | | | Vickers hardness | Catalyst | membrane |
| | | | content | dispersion | medium (mass %) | | | Dispersing | of dispersion | basis weight | Thickness |
| | Support | I/MO | (mass %) | medium | H₂O | EtOH | DAA | method | medium (GPa) | (mg/cm²) | (μm) |
| Example 1 | TiOx | 0.16 | 24 | DAA | 42 | 13 | 45 | HSM | 2.0 | 0.1 | 50 |
| Example 2 | TiOx | 0.16 | 24 | DAA | 42 | 13 | 45 | HSM | 2.0 | 0.4 | 10 |
| Example 3 | TiOx | 0.12 | 24 | DAA | 40 | 7 | 53 | HSM | 2.0 | 0.1 | 50 |
| Example 4 | TiOx | 0.12 | 24 | DAA | 40 | 7 | 53 | HSM | 2.0 | 0.4 | 10 |
| Example 5 | TiOx | 0.14 | 24 | DAA | 40 | 9 | 51 | HSM | 2.0 | 0.4 | 10 |
| Comparative | TiOx | 0.08 | 24 | DAA | 40 | 5 | 55 | HSM | 2.0 | 0.1 | 50 |
| Example 1 | | | | | | | | | | | |
| Comparative | TiOx | 0.32 | 24 | DAA | 42 | 21 | 37 | HSM | 2.0 | 0.1 | 50 |
| Example 2 | | | | | | | | | | | |
| Comparative | TiOx | 0.16 | 3 | DAA | 42 | 13 | 45 | HSM | 2.0 | 0.4 | 50 |
| Example 3 | | | | | | | | | | | |
| Comparative | TiOx | 0.16 | 24 | EtOH | 50 | 50 | 0 | BM | 12.5 | 0.4 | 10 |
| Example 4 | | | | | | | | | | | |
| Reference | C | 1.2 | 3 | EtOH | 50 | 50 | 0 | HSM | 2.0 | 0.4 | 10 |
| Example 1 | | | | | | | | | | | |

### 2. Study on the Ratio I/MO (Power Generation Test)

The membrane electrode assemblies of Examples 1 and 3 and Comparative Examples 1 and 2 were subjected to a power generation test. The details of the test are as follows.
Anode gas: Hydrogen gas at a relative humidity (RH) of 90% (bubbler dew point 58° C.)
Cathode gas: Air at a relative humidity (RH) of 90% (bubbler dew point 58° C.)
Cell temperature (cooling water temperature): 60° C.

FIG. 2 is a graph showing the results of the power generation test of the membrane electrode assemblies of Examples 1 and 3 and Comparative Examples 1 and 2. The data of Example 1 is represented by black squares. The data of Example 3 is represented by white triangles. The data of Comparative Example 1 is represented by black circles. The data of Comparative Example 2 is represented by white diamonds.

At a potential of 0.1 V, the current density is 0.4 mA/cm² in Comparative Example 1 and 0.2 mA/cm² in Comparative Example 2. That is, Comparative Examples 1 and 2 are both poor in power generation performance. Meanwhile, at a potential of 0.1 V, the current density is more than 0.5 mA/cm² in both Examples 1 and 2. That is, Examples 1 and 2 are both excellent in IV characteristic.

Therefore, compared to the case where the ratio I/MO is 0.08 (Comparative Example 1) or 0.32 (Comparative Example 2), excellent IV characteristic is obtained when the ratio I/MO is in a range of from 0.12 to 0.16.

For comparison to the case of using the carbon support, the membrane electrode assemblies of Examples 2, 4 and 5 and Reference Example 1 were subjected to a power generation test. The details of the test are as follows.

### (30% RH)

Anode gas: Hydrogen gas at a relative humidity (RH) of 30% (bubbler dew point 36° C.)
Cathode gas: Air at a relative humidity (RH) of 30% (bubbler dew point 36° C.)
Cell temperature (cooling water temperature): 60° C.

### (80% RH)

Anode gas: Hydrogen gas at a relative humidity (RH) of 80% (bubbler dew point 55° C.)
Cathode gas: Air at a relative humidity (RH) of 80% (bubbler dew point 55° C.)
Cell temperature (cooling water temperature): 60° C.

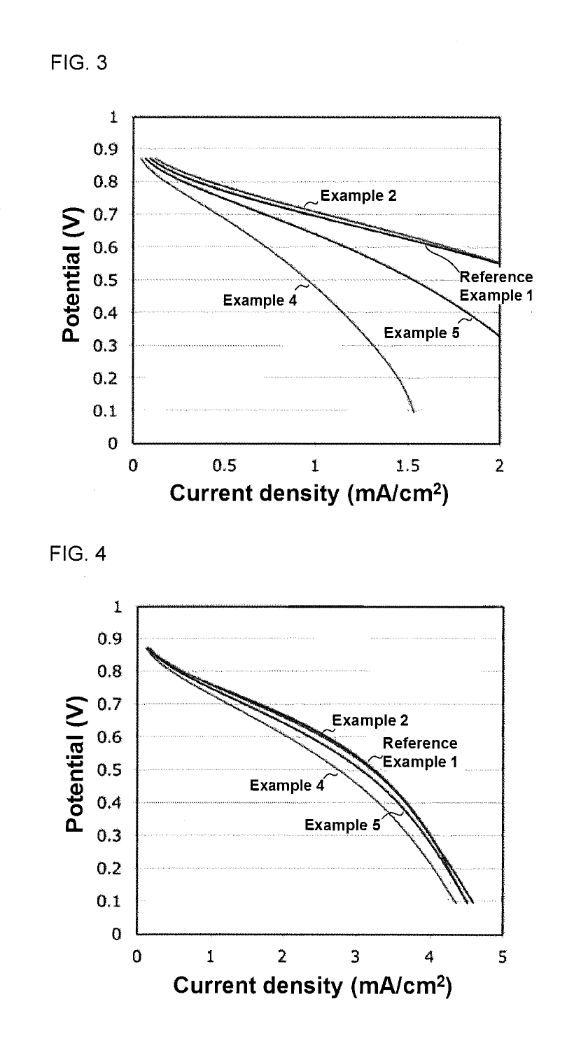

FIG. 3 is a graph showing the results of the power generation test of the membrane electrode assemblies of Examples 2, 4 and 5 and Reference Example 1, at a relative humidity of 30%.

When compared at the same potential, power generation performance increases in the order of Example 4, Example 5, Example 2. When Reference Example 1 (in which the carbon support was used) is determined as the reference, it can be said that Example 2 provides IV characteristic that is comparable to Reference Example 1.

Therefore, it is clear that in a low humidity condition, at least when the ratio I/MO is 0.16, IV characteristic as excellent as the conventional membrane electrode assembly using the carbon support, can be obtained.

As a result of comparing FIGS. 2 and 3, it is clear that IV characteristic is better in Examples 2, 4 and 5 than in Examples 1 and 3. This is because the electrolyte membrane is thinner and the cathode catalyst basis weight is larger in Examples 2, 4 and 5 than in Examples 1 and 3.

FIG. 4 is a graph showing the results of the power generation test of the membrane electrode assemblies of Examples 2, 4 and 5 and Reference Example 1, at a relative humidity of 80%.

As is clear from a comparison between FIGS. 3 and 4, in a high humidity condition, there is almost no difference between the IV characteristic of Examples 2 and 5 (in which the titanium oxide support was used) and the IV characteristic of Reference Example 1 (in which the carbon support was used). Meanwhile, it can be said that there is a small difference between the IV characteristic of Example 4 and the IV characteristic of Reference Example 1.

Therefore, it is clear that when the ratio I/MO of the membrane electrode assembly using the titanium oxide support is in a range of from 0.12 to 0.16, by appropriately controlling the humidity condition, the membrane electrode assembly can provide IV characteristic that is comparable to the conventional membrane electrode assembly using the carbon support.

The membrane electrode assemblies of Example 2 and Reference Example 1 were subjected to a durability test in the following condition. First, a potential of 2.05 V was applied to each membrane electrode assembly for one second. Then, a potential of 0.1 V was applied thereto for one second. These processes was determined as one cycle, and 1,200 cycles were repeated on each membrane electrode assembly. Then, a power generation test was carried out in the following condition to obtain an IV curve.
Anode gas: Hydrogen gas at a relative humidity (RH) of 90% (bubbler dew point 58° C.)
Cathode gas: Air at a relative humidity (RH) of 90% (bubbler dew point 58° C.)
Cell temperature (cooling water temperature): 60° C.

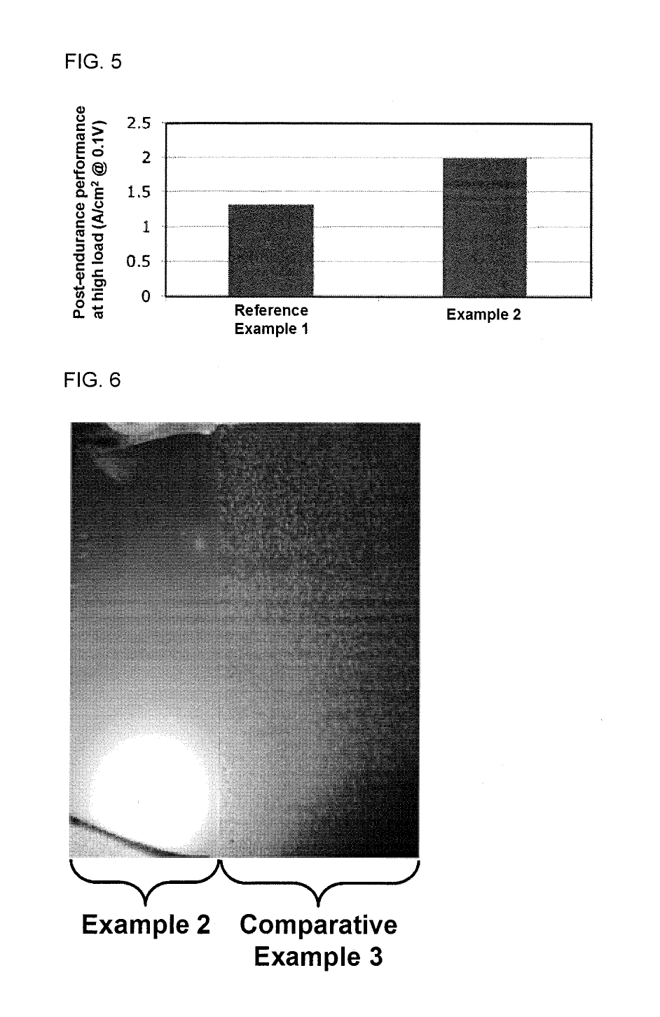

FIG. 5 is a bar chart comparing a current value at 0.1 V on the IV curve of Example 2 and a current value at 0.1 V on the IV curve of Reference Example 1. While the current value is 1.3 A/cm² in Reference Example 1, the current value is 2.0 A/cm² and high in Example 2.

As a result of considering the results shown in FIG. 5 and the results shown in FIGS. 3 and 4, it is clear that the membrane electrode assembly of Example 2 using the titanium oxide support, has higher durability than the membrane electrode assembly of Reference Example 1 using the carbon support, while it has the same level of power generation performance as Reference Example 1.

### 3. Study on the Solid Content (Evaluation of the Ability to Form the Anode Catalyst Layer)

The ability to form the anode catalyst layer was evaluated by comparing the examples using the catalyst inks that are different in solid content.

FIG. 6 is a photograph of the anode catalyst layer formed with the catalyst ink used in Example 2 and the anode catalyst layer formed with the catalyst ink used in Comparative Example 3.

As is clear from FIG. 6, in the case where the solid content was 3 mass % (Comparative Example 3), an anode catalyst layer having convexes and concaves on the surface thereof, was obtained. The reason is considered as follows. For the catalyst ink used in Comparative Example 3, the ratio I/MO is 0.16 and lower than the catalyst ink using the carbon support (see Reference Example 1). Therefore, when the solid content is as low as 3 mass %, the viscosity of the catalyst ink is insufficient. Due to the insufficient viscosity of the catalyst ink, a coating film formed by thinly applying the ink on a surface of a substrate, is uneven. As a result, an uneven anode catalyst layer is obtained.

Meanwhile, in the case where the solid content is 24 mass % (Example 2), an anode catalyst layer having a flat and smooth surface was obtained. The reason is considered as follows: since the solid content is sufficiently high, the catalyst ink has appropriate viscosity, and an even coating film is obtained when the catalyst ink is thinly applied on the substrate surface.

Therefore, it is considered as follows: to form an even and transferable anode catalyst layer, the solid content of the catalyst ink needs to be 24 mass % or more.

### 4. Study on the Dispersion Medium and Dispersing Method of the Catalyst Ink (Power Generation Test)

The membrane electrode assemblies of Example 2 and Comparative Example 4 were subjected to a power generation test. The details of the test are as follows.
Anode gas: Hydrogen gas at a relative humidity (RH) of 90% (bubbler dew point 77° C.)
Cathode gas: Air at a relative humidity (RH) of 90% (bubbler dew point 77° C.)
Cell temperature (cooling water temperature): 80° C.

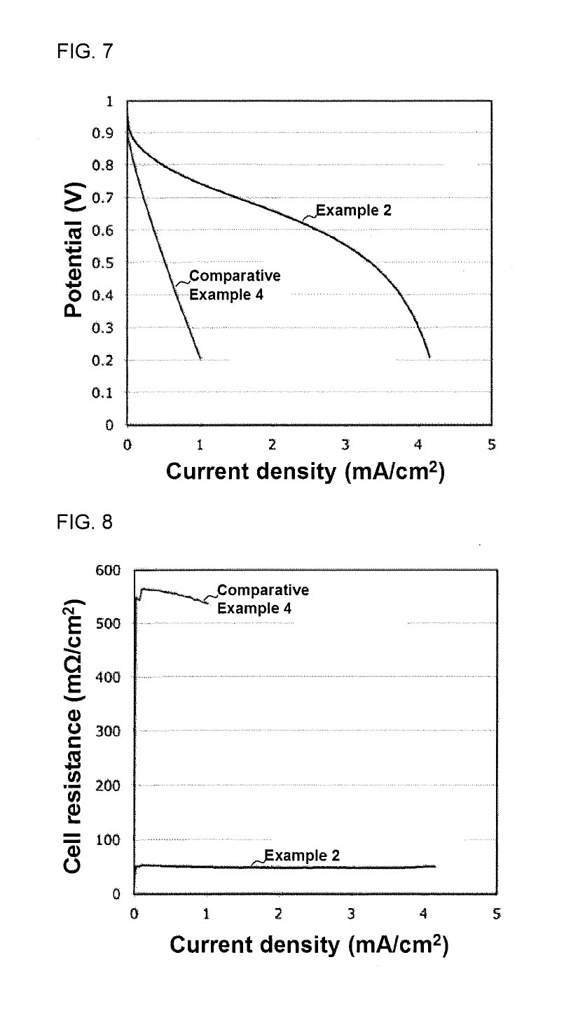

FIG. 7 is a graph showing the IV curve of the membrane electrode assembly of Example 2 along with the IV curve of the membrane electrode assembly of Comparative Example 4. At a potential of 0.2 V, the current density is 1 mA/cm² in Comparative Example 4, and Comparative Example 4 is poor in power generation performance. Meanwhile, at a potential of 0.2 V, the current density is more than 4 mA/cm² in Example 2, and Example 2 is excellent in power generation performance.

FIG. 8 is a graph showing a change in cell resistance of the membrane electrode assembly of Example 2 along with a change in cell resistance of the membrane electrode assembly of Comparative Example 4. According to FIG. 8, while the cell resistance of Example 2 is 50 mΩ/cm², the cell resistance of Comparative Example 4 is more than 500 mΩ/cm².

Therefore, it is clear that in the case where the aqueous solution containing diacetone alcohol as the main component, is used as the dispersion medium of the catalyst ink, and the catalyst ink is dispersed by the high-shear mixer (Example 2), the thus-obtained membrane electrode assembly is better in power generation performance and smaller in cell resistance than the case where the ethanol aqueous solution is used as the dispersion medium of the catalyst ink, and the catalyst ink is dispersed by the planetary ball mill (Comparative Example 4).

From the above, it is clear that in the case where (1) the ratio (I/MO) is in a range of from 0.12 to 0.16, (2) the solid content is 24 mass % or more, (3) the materials for the catalyst layer are mixed in the mixing step by the use of the dispersion medium where the content ratio of the diacetone alcohol is the highest, and (4) the solid having a Vickers hardness lower than titania is used as the medium in the dispersing step (Examples 1 to 5), such a fuel cell catalyst layer that can prevent an increase in cell resistance, has excellent in IV characteristic and is even, can be produced compared to the case where a part of the mixing and dispersing conditions differ (Comparative Examples 1 to 4). The reason why an increase in cell resistance is prevented, is considered that the dispersion medium composition and the dispersing condition are those that can avoid physical damage to and chemical deterioration of the titanium oxide support. The reason for the excellent IV characteristic is considered that the range of the ratio (I/MO) is optimal for the titanium oxide support. The reason why the fuel cell catalyst layer is even, is considered that the solid content is optimal.

### REFERENCE SIGNS LIST

1. Polyelectrolyte membrane
2. Cathode catalyst layer
3. Anode catalyst layer
4, 5. Gas diffusion layer
6. Cathode
7. Anode
8. Membrane electrode assembly
9, 10. Separator
11. Oxidant gas channel
12. Fuel gas channel
21. Ionomer
22. Catalyst composite that is relatively large in particle diameter
23. Catalyst composite that is relatively small in particle diameter
100. Fuel cell

1. A method for producing a fuel cell catalyst layer, the method comprising the steps of:
preparing a catalyst composite that comprises a titanium oxide support and platinum or a platinum alloy supported on a surface thereof, the titanium oxide support comprising Ti₄O₇ as a main component, and an ionomer that is a proton-conductive polymer;
mixing the catalyst composite, the ionomer, and a dispersion medium containing at least water and a tertiary alcohol having from 4 to 6 carbon atoms where a content ratio of the tertiary alcohol is the highest, in such conditions that a ratio (I/MO) of a mass (I) of the ionomer to a mass (MO) of the titanium oxide support is in a range of from 0.12 to 0.16, and a content of a solid comprising the catalyst composite and the ionomer is 24 mass % or more; and,
while pulverizing aggregates comprising the catalyst composite and the ionomer by use of at least one medium selected from the group consisting of a gas, a liquid, and a solid having a Vickers hardness lower than titania, dispersing a mixture obtained by the pulverization in the dispersion medium.

2. The method for producing the fuel cell catalyst layer according to claim 1, the method comprising the step of forming a catalyst layer on a surface of an electrolyte membrane by at least one method selected from the group consisting of a casting method, a screen printing method, a doctor blade method, a gravure printing method and a die coating method.

3. The method for producing the fuel cell catalyst layer according to claim 1, wherein the ratio (I/MO) is from 0.14 to 0.16.

4. The method for producing the fuel cell catalyst layer according to claim 1, wherein the tertiary alcohol is diacetone alcohol or t-butyl alcohol.

5. The method for producing the fuel cell catalyst layer according to claim 1, wherein a high-shear mixer or a homogenizer is used in the dispersing step.

6. The method for producing the fuel cell catalyst layer according to claim 1, wherein the fuel cell catalyst layer is a fuel cell catalyst layer for an anode.
